(19) United States
(12) Patent Application Publication
(10) Pub. No.: US 2008/0263400 A1
(43) Pub. Date: Oct. 23, 2008

(54) Fault insertion system

(75) Inventors: Cullen J. Waters, Redmond, WA (US); Michael N. Frost, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/788,978

(22) Filed: Apr. 23, 2007

(51) Int. Cl. G06F 11/00

(52) U.S. Cl. 714/30

(57) ABSTRACT

A method of scheduling a simulated hardware fault on a computer system by specifying at least a termination point where the simulated hardware fault will be automatically removed from the computer system. The computer system may comprise at least one control computer that can be remote from a computer into which a simulated hardware fault is inserted and that schedules and controls simulation of the simulated hardware fault.

### BACKGROUND

Virtually any computing device may experience hardware faults which can interfere with or preclude the computing device from performing its intended functionality. To provide reliable and highly available computing devices and systems, the devices can be tested for fault tolerance and other conditions by simulating hardware faults on the devices and evaluating performance of the devices and/or systems in which they are employed when the faults are in effect.

Conventionally, to simulate hardware faults on a computing device, the device is directly accessed physically to change its state.

Thus, conventionally it is required to physically login to each computer to start simulated faults, and also to remove them once testing is complete. Applicants have appreciated that fault tolerance, stress, performance and other types of testing of computer systems with multiple computers may be time and manual labor intensive when each computer must be accessed directly to simulate hardware faults and/or hardware-fault caused software faults.

### SUMMARY OF INVENTION

One embodiment is directed to a method for use in a computer system. The method comprises scheduling a simulated hardware fault on the computer system by specifying at least a termination point where the simulated hardware fault will be automatically removed from the computer system and executing at least one test that tests performance of the computer system while the simulated hardware failure is in effect.

Another embodiment is directed to a computer system comprising a plurality of computers, at least one communication medium that couples together the plurality of computers, and at least one fault insertion module that is adapted to schedule at least one simulated hardware fault on the computer system by specifying at least a termination point where the simulated hardware fault will be automatically removed from the computer system.

A further embodiment is directed to a computer system comprising at least one hardware component, and at least one processor programmed to insert at least one simulated fault into the at least one hardware component and to automatically remove the at least one simulated fault when it is determined that a specified termination point has been reached.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a conceptual illustration of a computer system in which a method of scheduling simulated hardware faults in accordance with embodiments of the present invention can be implemented;

FIG. 2 is a diagram illustrating a conceptual example of the manner in which the computer system of FIG. 1 can be implemented;

FIG. 3 is a flow chart of a process of scheduling a simulated hardware fault on a computer system in accordance with one embodiment of the present invention; and

FIG. 4 is a diagram illustrating an exemplary computer system on which embodiments of the present invention may be implemented.

### DETAILED DESCRIPTION

Embodiments of the present invention are directed to scheduling simulated hardware faults on a computer system. The computer system may be of any type and may include any number of computers interconnected in any way. Applicants have appreciated that drawbacks associated with conventional techniques for inserting simulated hardware faults into a computer system to evaluate performance of the computer system under fault conditions can be alleviated by scheduling simulated hardware faults.

In one embodiment, scheduling simulated hardware faults on a computer system includes specifying a termination point at which a simulated hardware fault will be automatically removed from the computer system. Specifying the termination point as part of scheduling simulated hardware faults is advantageous in that it allows one or more simulated hardware faults to be removed without directly accessing the computer system.

While one or more simulated hardware faults are in effect, one or more tests can be executed to test performance of the computer system experiencing the simulated hardware fault(s). An example of such tests includes fault tolerance testing to see how the system reacts to the simulated fault. In addition, stress testing and/or load testing can be performed to assess how the computer system functions beyond normal operational capacity. Fault tolerance testing may be performed simultaneously with load and/or stress testing. It should be appreciated that the aspects of the invention described herein are not limited in this respect, and that any desired tests can be performed on a computer system on which embodiments on the invention are implemented to schedule one or more simulated hardware faults. It should also be appreciated that testing can be performed using any suitable testing system.

As used herein, a simulated hardware fault refers to configuring a computer so that it mimics the way in which the computer will function if a hardware fault were to occur. To simulate a hardware fault, code (e.g., software instructions, microcode instructions, etc.) may be provided to the computer system or its component(s) that, when executed, simulate one or more hardware faults. Simulated hardware faults may be simulated failures of hardware components of the computer system, simulated bottlenecks of resources of a computer system, and/or other types of faults. Examples of simulated hardware faults include memory faults wherein content of a memory location is corrupted, a network interface controller (NIC) failure, faults caused by network traffic exceeding processing capacity of the computer system, low virtual memory, high utilization of a processor, disk failure, low disk space, unexpected system shutdown, vulnerability to a denial-of-service (DOS) attack, unavailability of a domain name system (DNS) server, unintended enabling/disabling of certain services, problems with Internet Information Services (IIS), and any other simulated hardware faults. These are merely examples, as embodiments described herein are not limited to simulating any specific types of hardware faults.

In accordance with one embodiment, a simulated hardware fault may be scheduled to automatically terminate at a specified point, which may be specified in any suitable way (e.g., by a specified time or event). Optionally, a simulated hardware fault may also be scheduled to begin at a specified point.

In accordance with yet another embodiment, in addition to specifying the termination point, a beginning point where the simulated hardware fault is to take effect is specified as part of scheduling a simulated hardware fault. The termination and beginning points may be a date, a time, duration of time, a specified event and/or any other suitable point.

In accordance with one embodiment, scheduling may be performed automatically. For example, an application programming interface (API) may be employed to schedule simulated hardware faults to a computer system. A component, such as, for example, software code or a component implemented in any other suitable way, may be provided to the computer system to schedule the simulated hardware faults. The component may be pre-installed and/or pre-configured on the computer system prior to scheduling the faults. Alternatively, the component may be received by the computer system (e.g., downloaded from a web server) at any suitable point and in any suitable way. However, it should be appreciated that the aspects of the invention described herein are not limited in this respect, and that scheduling may be performed in any way. For example, a user interface (UI) API may be provided whereby a user can specify simulated hardware faults, beginning and/or termination points for each fault, and/or other parameters associated with the simulated hardware faults.

In accordance with another embodiment of the present invention, techniques can be employed to enable a simulated hardware fault to be inserted on at least one computer in a computer system from a remote location (e.g., via another computer connected to the computer into which the simulated fault is inserted in any suitable manner, such as via a network or otherwise). In a further embodiment, a single remote computer can be employed to insert one or more simulated faults into multiple computers in a computer system. By enabling faults to be inserted into one or more computer systems remotely, convenience can be employed in inserting faults and testing a computer system, as it becomes unnecessary for an administrator to physically visit each computer to initiate and/or terminate a simulated hardware fault. It should be appreciated that the embodiments of the present invention that relate to scheduling a simulated hardware fault and to controlling the implementation of a hardware fault remotely can be employed separately or together.

In accordance with one embodiment, the computer system comprises a plurality of computers and at least one control computer to initiate the simulated hardware faults on the plurality of computers. However, it should be appreciated that the aspects of the invention described herein are not limited in this respect, and that the scheduling techniques described herein can be employed on any computer system. In the embodiment that employs a centralized control computer, the control computer may provide a way to identify one or more computers from a plurality of computers on which hardware faults may be simulated and the types of hardware faults than can be simulated on each computer. In one embodiment, this information can be discovered and presented (e.g., via a user interface on the control computer) to a user to facilitate initiating and/or scheduling faults.

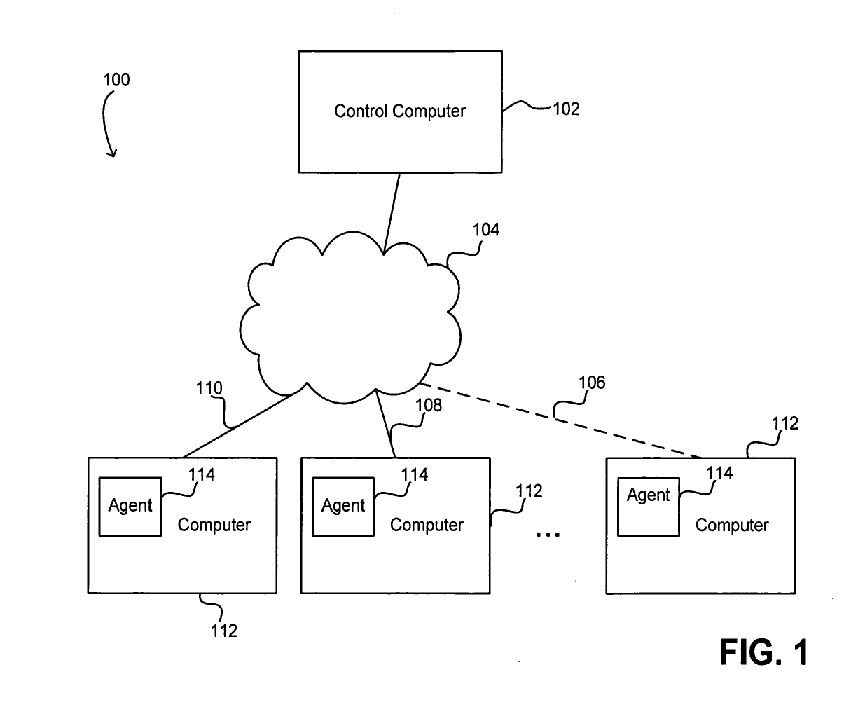

As discussed above, in accordance with one embodiment of the invention, a computer system on which scheduling of simulated hardware faults is implemented comprises a plurality of computers and at least one control computer to initiate the simulated hardware faults on the plurality of computers. Employing the control computer may simplify hardware fault simulation and provide a centralized way to control such simulations. FIG. 1 illustrates an example of a computer system 100 that comprises a control computer 102 to schedule and control simulation of simulated hardware faults and a plurality of computers 112 on which the simulated hardware faults may be simulated. The control computer 102 can be connected to the computers 112 in any suitable way, as illustrated conceptually via a cloud 104. While three computers 112 are illustrated in FIG. 1, it should be appreciated that the aspects of the invention described herein are not limited to use with a computer system that employs any particular number of computers and can be implemented in a computer system that comprises a single computer or any number of multiple computers. The control computer 102 may communicate with one or more of the computers 112 over a wireless network illustrated conceptually by a dotted line shown at 106 in FIG. 1, and/or via a wired connection illustrated at 108 and 110 in FIG. 1. Each wireless or wired connection may include a local area network (LAN), a wide area network (WAN), the Internet, or any other connection. The aspects of the invention described herein are not limited in any respect by the manner in which the control computer 102 communicates with the computers 112, and in which the computers 112 communicate with each other (if at all).

The control computer 102 may be a personal computer, a workstation, a server, a mainframe computer, or any other computer system. It should be appreciated that the control computer 102 may be distributed among one or more computers. Furthermore, the control computer 102 may be dedicated to administrative functions for the computer system 100 or may be implemented on one or more of the computers 112 that perform other functions.

In the example illustrated, scheduling and/or initiating of simulated hardware faults is performed via the control computer 102. However, it should be appreciated that the simulated hardware faults may be scheduled and/or initiated via any other computer, including, for example, on one or more of the computers 112.

To schedule and/or initiate simulated hardware faults on a computer 112, a component may be deployed on the computer 112 which controls and/or implements the simulated faults. In the implementation illustrated in FIG. 1, each computer 112 comprises an agent 114 which is such component (e.g., a software component) through which simulated hardware faults can be scheduled and/or initiated on the computers 112. As discussed above, agents 114 may be pre-installed/pre-loaded and/or pre-configured on the computers 112 prior to initiating or scheduling a particular simulated fault. Alternatively, the agents 114 may be deployed on the computers 112 by being loaded upon scheduling and/or initiating at least one simulated hardware fault or at any other point. In yet another embodiment, different components (not shown) of any of the agents 114 may be loaded at different points. It should be appreciated that the aspects of the invention described herein are not limited in this respect, and that the agents 114 can be provided to the computers 112 in any suitable way.

The agents 114 interact with the control computer 102 to allow scheduling, initiating and/or removing simulated hardware faults in a manner that does not require an administrator to physically access each computer 112. For example, in an embodiment of the invention where the control computer 102 is remotely connected to a computer with the capability of simulating one or more hardware faults (e.g., one or more of the computers 112), the control computer 102 can provide instructions to the computer to initiate or schedule a hardware fault (e.g., to shut down a NIC on the computer to simulate the loss of network connectivity).

The agents 114 may include one or more components of any type, as discussed in more detail below. For example, in one embodiment of the invention, an agent may be a software component and may include a shared folder which is shared among and accessible by the agent, and the control computer 102 (and/or optionally other agents). The control computer 102 may push instructions for scheduling simulated faults down to the agent by modifying the contents of the shared folder. Any of the agents 114 may monitor its shared folder by checking, either continuously or at specified intervals, whether any simulated faults have been scheduled. If the shared folder contains information on scheduled faults to be simulated, the faults may be initiated at a specified starting point and/or stopped at a specified termination point. It should be appreciated that the aspects of the invention described herein are not limited to any particular ways in which the control computer can initiate and/or schedule hardware fault simulation on the plurality of computers, as that controlling can be carried out in any suitable manner.

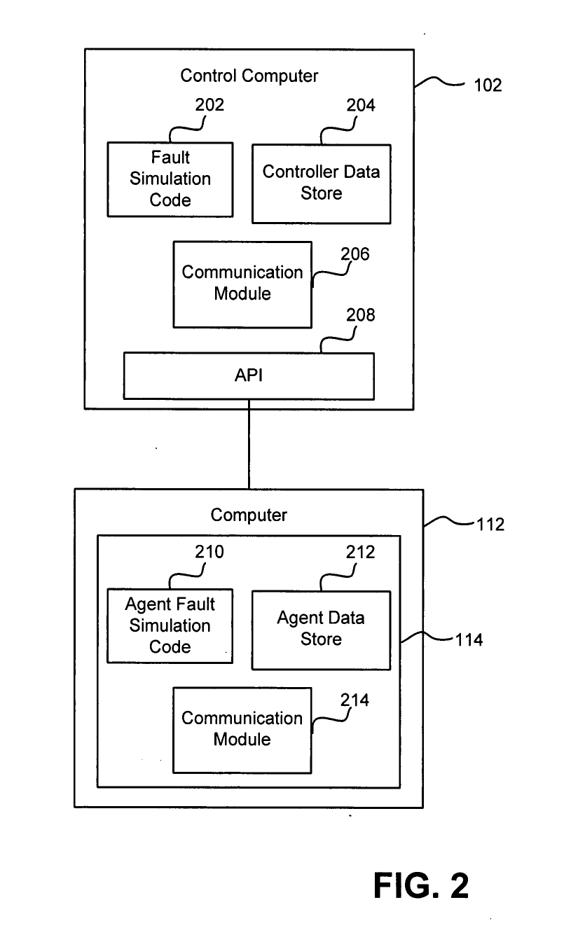

FIG. 2 is a diagram illustrating a conceptual example of components that may be included in the control computer 102 and any of the computers 122 to implement aspects of the invention described herein. These components are shown purely for illustration purposes, as other implementations are possible. In the example illustrated, the control computer 102 may include a fault simulation code module 202 that may implement scheduling and/or initiating of simulated hardware faults, a controller data store module 204 that may include data on the computer(s) 112 and simulated hardware faults to be simulated thereon, including, in some embodiments, data related to points of beginning and/or terminating of simulated hardware faults (e.g., a time, a date, an event, or any other point) and parameters associated with the simulated hardware faults. Furthermore, the control computer 102 may comprise a communication module 206 to facilitate communication between the control computer 102 and the computer 112. The modules 202, 204 and 206 may interact in any suitable way.

In one embodiment of the invention, the control computer 102 may include one or more APIs 208 whereby the control computer 102 may schedule simulated hardware faults and provide the scheduled faults to the computer 112. It should be appreciated that the API 208 can be used to provide the simulated faults to the computer 112 automatically, manually, or in any suitable way.

In one embodiment of the invention, communication between the control computer and one or more computers on which a fault is to be initiated and/or scheduled may be in the form of one or more Extensible Markup Language (XML) documents containing information on the simulated hardware faults.

As discussed above, a simulated hardware fault may be scheduled to be initiated at a beginning point and/or to be removed at a termination point. A fault may be characterized by variable or predefined parameters, or specified in any other suitable way. Accordingly, the API 108 may be used to specify the parameters, which may be accomplished automatically or in other way. The API 208 may also be used to add simulated hardware faults to a list of simulated hardware faults on the control computer 102 (e.g., simulated hardware faults stored in the controller data store 204) available for selection.

In one embodiment of the invention, one or more simulated hardware faults may be implemented as a plug-in. Each plug-in can be written separately from, but can be integrated with, code implementing the agent (e.g., 210 and 212) in embodiments of the invention. The implementation of simulated hardware faults via plug-ins provides flexibility in adding new simulated hardware faults, as the agent code need not be rewritten each time a new fault is added. Any suitable component may be used to install any simulated hardware fault plug-ins to computer122.

In one embodiment of the invention, a user interface API may be provided (not shown) whereby a user may specify one or more of the computers 112 to be tested for fault tolerance and other conditions. The user may also specify which faults are to be simulated on the computers to be tested, and any parameters associated with hardware faults may be specified by the user. It should be appreciated that the aspects of the invention described herein are not limited in the way in which scheduled hardware faults are provided to computers to be tested, and that this can be achieved in any suitable manner (e.g., via the control computer or otherwise).

As discussed above, FIG. 2 illustrates an illustrative implementation of an agent 114 for executing on a computer on which hardware faults may be simulated. The agent 114 may comprise an agent fault simulation code module 210 that includes code for fault initiation and fault removal from the computer 112, an agent data store 212 containing data (e.g., in the shared folder described above or otherwise) and a communication module 214 that facilitates communication between the computer 112 and the control computer 102. The agent data store 212 may contain data on types of faults that can be scheduled on the computer 112, specifying information concerning any initiated or scheduled faults, such as, for example, beginning and termination points for each simulated hardware fault, fault parameters, and/or other data. It should also be appreciated that the agent 114 is shown in FIG. 2 as comprising components 210, 212 and 214 as a mere high-level concept of a functionality provided by the agent 114, and that the agent 114 may comprise other components. In addition, this is just illustrative, as agent 114 can be implemented in other ways.

In one embodiment of the invention, the agent 114 may be obtained by the computer 112 from the control computer 102 prior to scheduling or initiating any simulated hardware faults (e.g., the agent may be pre-installed and/or pre-configured on the computer 112), after scheduling, or at any other point. In an alternate embodiment, the agent 114 may be obtained from another entity (e.g., downloaded from a web server) in any suitable way. As described above in one embodiment, the agent 114 includes data on simulated hardware faults that can be simulated on the computer 112. If it is desired to implement a new simulated hardware fault on the computer 112, code to implement this fault may be is provided to the agent 114, either by the control computer 102 or in any other way.

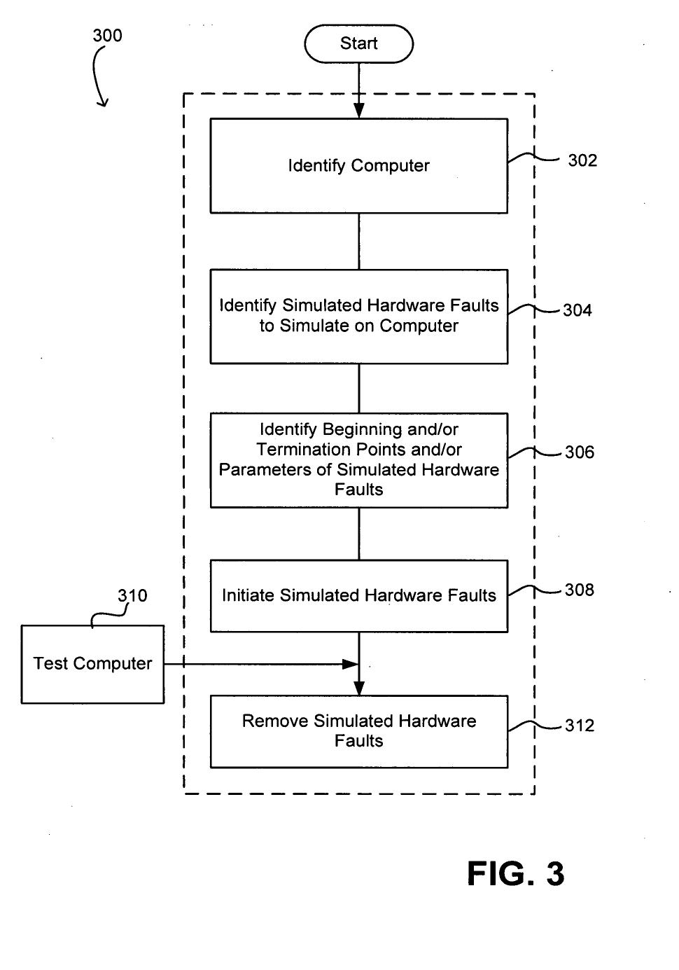

FIG. 3 is a flow chart illustrating a method 300 of scheduling a simulated hardware fault on a computer system (e.g., a computer system comprising the control computer 102 and the plurality of computers 112 of FIG. 1.), according to one embodiment. Any number of computers can be included in the computer system. Also, any number of simulated hardware faults of any type can be simulated. The process can be initiated upon a command issued via the user interface of the control computer or in any other suitable way.

In act 302, a computer may be identified to test and evaluate its performance (or the performance of the system) when a simulated hardware fault is in effect on the identified computer. As discussed above, any number of computers of any type (e.g., computers 112) can have a hardware fault simulated thereon. In one embodiment, the control computer includes information on the computers it is configured to control (i.e., to initiate and/or schedule faults) and on the types and characteristics of hardware faults that can be simulated on the computers. Accordingly, to schedule at least one simulated hardware fault, the computer on which a fault is to be simulated may be identified, in act 302.

In act 304, hardware faults to be simulated on the computer identified in act 302 are identified. The simulated hardware faults may be included, for example, in the controller data store 204 shown in FIG. 2, and may be identified for simulation via the API 208, a user interface, or in any other suitable way.

In act 306, beginning and termination points for each simulated hardware fault may be specified, as well as any parameters associated with simulated hardware fault. For example, a user interface may be provided on the control computer for a user to enter beginning and/or termination points and/or any parameters. The parameters may be a predetermined list of parameters and its values, or may be identified in other suitable form. Although beginning and termination points and parameters are defined in the embodiment shown, it should be appreciated that the invention is not limited in this respect, as in alternative embodiments, no parameters need be provided and/or one or more faults can be initiated immediately without scheduling a beginning point and/or termination point.

In act 308, the identified simulated hardware faults may be initiated, either at the beginning point identified in act 306 or at any other suitable point (e.g., immediately). Initiating may comprise starting a simulation of a simulated hardware fault, (e.g., by executing code (e.g., in a plug-in)) for executing the simulated hardware fault.

In act 310, the computer (and/or a large system including the computer) with the simulated hardware fault(s) in effect can be tested. It should be appreciated that the testing may be performed at any point of operation of the computer and is shown as taking place after act 308 for the sole purpose of illustration, as the testing can be begin before the fault is simulated for comparison purposes. The testing may include any type of assessing how the simulated hardware faults affect operation and functioning of the computer, and/or its component(s), and/or a system including the computer. For example, the testing can be fault tolerance testing, stress and/or any other type of testing. The computer system may include more than one computer and a plurality of computers included in the system may be tested simultaneously. For example, performance of the entire computer system can be evaluated.

It should be appreciated that act 310 may be performed using any suitable program, system or device, as the embodiments of the invention are not limited in this respect. For example, any hardware-testing software or testing system can be employed to perform testing of the computer (or a system that includes it) with one or more simulated hardware faults in effect.

In one embodiment, an indication of which simulated hardware faults were in effect at which time may be provided. In one embodiment, a report (e.g., in printed or digital form) may be provided demonstrating which faults were effect when.

In an embodiment of the invention, the testing can be performed manually. For example, a user may supervise a computer while simulated hardware faults in effect on the computer. However, it should be appreciated testing can be performed in any suitable manner and that the aspects of the invention described herein are not limited in this way.

Although in one embodiment of the present invention the system for initiating and scheduling simulated hardware faults can be provided in a manner completely independent from one or more systems for testing the computer on which the faults are implemented, the present invention is not limited in this respect. In accordance with one embodiment of the present invention, the system for initiating and/or scheduling simulated hardware faults can be provided with an interface (e.g., an API) that enables the fault initiating/scheduling system to be integrated with one or more testing systems that test the performance of the computer while simulated faults are in effect. By integrating the testing and fault initiating/scheduling systems, the testing system can be automatically made aware of which faults were in effect when and correlate those faults to the testing results in any desired manner automatically, without requiring manual intervention. This aspect of the present invention is not limited to any particular implementation technique, as any suitable interface for interfacing the fault initiation/scheduling system with one or more testing systems can be employed.

In act 312, the simulated hardware faults may be removed. This can be performed at the termination point, which can be a time, a date, an event or any other suitable point. As discussed above, a computer (e.g., the control computer 102) can provide scheduling of simulated hardware faults including specifying a termination point. Therefore, a simulated hardware fault can be removed automatically from a computer with the fault being simulated. A simulated hardware fault can be removed automatically in any of numerous ways. For example, in one embodiment, the local agent that implements the hardware fault can determine on its own that the termination point has been reached, and take the appropriate action. Alternatively, in another embodiment, the control computer 102 can determine that the termination point has been reached and instruct the local agent accordingly.

Simulated hardware faults can be removed in any suitable manner as the aspects of the present invention described herein are not limited in this respect. For example, if the simulated hardware fault was a failure of a network controller, such that the fault was simulated by turning off the network controller to lose network connectivity, removing the fault can simply involve turning a network controller back on to re-establish network connectivity.

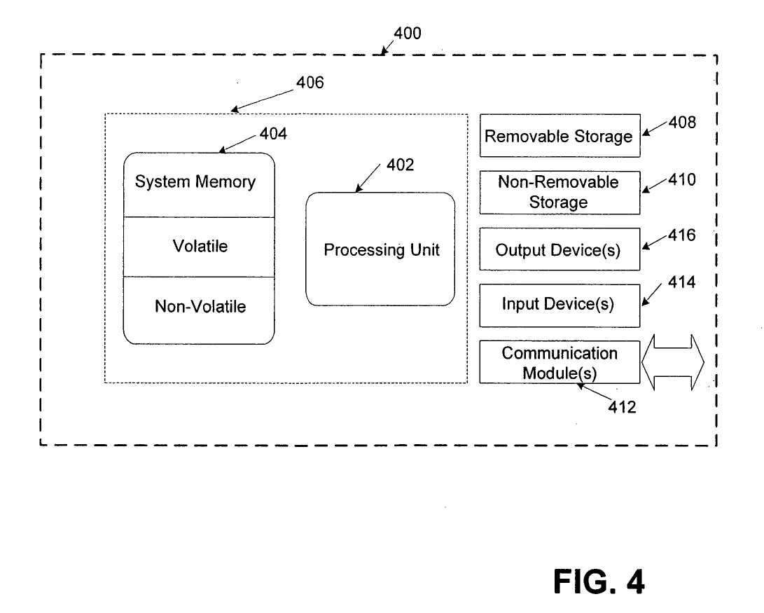

With reference to FIG. 4, an exemplary system for implementing some embodiments is illustrated. FIG. 4 illustrates computing device 400, which may be a device suitable to function as any of the computers 112 and/or the control computer 102. Computing device 400 may include at least one processor 402 and memory 404. Depending on the configuration and type of computing device, memory 404 may be volatile (such as RAM), non-volatile (such as ROM, flash memory, etc.) or some combination of the two. This configuration is illustrated in FIG. 4 by dashed line 406.

Device 400 may include at least some form of computer readable media. By way of example, and not limitation, computer readable media may comprise computer storage media. For example, device 400 may also include storage (removable and/or non-removable) including, but not limited to, magnetic or optical disks or tape. Such additional storage is illustrated in FIG. 4 by removable storage 408 and non-removable storage 410. Computer storage media may include volatile and nonvolatile media, removable, and non-removable media of any type for storing information such as computer readable instructions, data structures, program modules or other data. Memory 404, removable storage 408 and non-removable storage 410 all are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400. Device 400 may also contain network communications module(s) 412 that allow the device to communicate with other devices via one or more communication media. By way of example, and not limitation, communication media may include wired media such as a wired network or direct-wired connection, and wireless media such as acoustic, RF, infrared and other wireless media. Network communication module(s) 412 may be a component that is capable of providing an interface between device 400 and the one or more communication media, and may be one or more of a wired network card, a wireless network card, a modem, an infrared transceiver, an acoustic transceiver and/or any other suitable type of network communication module.

Device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be appreciated that the techniques described herein are not limited to executing on any particular system or group of systems. For example, embodiments may run on one device or on a combination of devices. Also, it should be appreciated that the techniques described herein are not limited to any particular architecture, network, or communication protocol.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The techniques described herein are not limited in their application to the details of construction and the arrangement of components set forth in the following description or illustrated in the drawings. The techniques described herein are capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for use in a computer system, the method comprising acts of:
(A) scheduling a simulated hardware fault on the computer system by specifying at least a termination point where the simulated hardware fault will be automatically removed from the computer system; and
(B) executing at least one test that tests performance of the computer system while the simulated hardware failure is in effect.

2. The method of claim 1, wherein the simulated hardware fault simulates failure of at least one hardware component in the computer system.

3. The method of claim 1, wherein the simulated hardware fault simulates at least one bottleneck in at least one resource of the computer system.

4. The method of claim 1, wherein the scheduling of the simulated hardware fault further comprises specifying a beginning point where the simulated hardware fault is to take effect.

5. The method of claim 1, wherein the computer system comprises at least a first computer, wherein the simulated hardware fault is to be simulated on the first computer, and wherein the act (A) is initiated via a second computer that is remote from the first computer.

6. The method of claim 1, wherein the computer system comprises a plurality of computers and at least one control computer, and wherein the act (A) is initiated via the at least one control computer.

7. A computer system comprising:
a plurality of computers;
at least one communication medium that couples together the plurality of computers; and
at least one fault insertion module that is adapted to schedule at least one simulated hardware fault on the computer system by specifying at least a termination point where the simulated hardware fault will be automatically removed from the computer system.

8. The computer system of claim 7, wherein the at least one simulated hardware fault simulates failure of at least one hardware component in the computer system.

9. The computer system of claim 7, wherein the at least one simulated hardware fault simulates at least one bottleneck in at least one resource of the computer system.

10. The computer system of claim 7, wherein the at least one fault insertion module is further adapted to schedule the at least one simulated hardware fault on the computer system by specifying a beginning point where the at least one simulated hardware fault is to take effect.

11. The computer system of claim 7, wherein the plurality of computers comprises at least a first computer and a second computer, and wherein the at least one fault insertion module is disposed on the first computer and is adapted to schedule the at least one simulated hardware fault on the second computer.

12. The computer system of claim 7, wherein the computer system further comprises at least one testing module, and wherein the at least one fault insertion module is coupled to the at least one testing module to enable automatic correlation between the at least one simulated hardware fault and the performance of the computer system tested by the at least one testing module.

13. The computer system of claim 11, wherein the plurality of computers further comprises at least a third computer, and wherein the at least one fault insertion module is further adapted to schedule the at least one simulated hardware fault on the third computer.

14. The computer system of claim 7, wherein at least one computer from the plurality of computers comprises an agent that is adapted to receive at least one instruction from the at least one fault insertion module instructing the agent to insert the at least one simulated hardware fault into at least one hardware component of the at least one computer and to automatically remove the at least one simulated hardware fault when it is determined that the termination point has been reached.

15. A computer system comprising:
at least one hardware component; and
at least one processor programmed to insert at least one simulated fault into the at least one hardware component and to automatically remove the at least one simulated fault when it is determined that a specified termination point has been reached.

16. The computer system of claim 15, wherein the at least one simulated fault simulates failure of the at least one hardware component.

17. The computer system of claim 15, wherein the simulated hardware fault simulates at least one bottleneck in at least one resource of the computer system.

18. The computer system of claim 15, wherein the at least one processor is programmed to insert the at least one simulated fault into the at least one hardware component at a specified beginning point.

19. The computer system of claim 16, wherein the at least one processor is instructed via at least one control computer to insert the at least one simulated fault into the at least one hardware component and to automatically remove the at least one simulated fault.

20. The computer system of claim 19, wherein the at least one control computer is remote from the computer system.
